(19) United States
(12) Patent Application Publication
(10) Pub. No.: US 2003/0080216 A1
(43) Pub. Date: May 1, 2003

(54) Fuel injection system for internal combustion engines

(76) Inventors: Peter Boehland, Marbach (DE); Sebastian Kanne, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/149,899

(22) PCT Filed: Sep. 19, 2001
(86) PCT No.: PCT/DE01/03594

(30) Foreign Application Priority Data
Oct. 18, 2000 (DE) 100515487

(51) Int. Cl. F02M 59/00

(52) U.S. Cl. 239/533.2

(57) ABSTRACT

A fuel injection system having a fuel injection valve (1), which has a valve body (20) in which a valve member (60) is disposed axially movably in a bore (62), which valve member is longitudinally displaceable, hydraulically controlled by the fuel pressure in a pressure chamber (64), counter to a closing force and thereby controls at least one injection opening (68). A control valve (30) is disposed in the fuel injection valve; it includes a control valve member (32) that is longitudinally displaceable in a control valve bore (38), which control valve member (32), in a first position, opens the communication from a high-pressure fuel source (10) to the pressure chamber (64) and, in a second position, connects the pressure chamber (64) to a control chamber (50) and thereby interrupts the communication with the high-pressure fuel source (10). The pressure wave that occurs upon closure of the control valve (30) reaches the control chamber (50), which communicates with a relief chamber (72) via a receiving bore (43), in which receiving bore (43) a thrust bolt (45) is guided that moves longitudinally synchronously with the valve member (60) via a rigid connection, and which thrust bolt (45), by means of the hydraulic forces of the pressure wave and by its longitudinal motion, urges the valve member (60) in the closing direction (FIG. 1).

### PRIOR ART

The invention is based on a fuel injection system as generically defined by the preamble to claim 1. One such fuel injection system is known from German Patent Disclosure DE 197 01 897 A1, for instance. In such a fuel injection system, fuel is pumped by a high-pressure fuel pump into a high-pressure collection chamber (common rail), in which a specified high fuel pressure is maintained. From this common rail, high-pressure lines lead to each fuel injection valve, and the fuel injection valves inject fuel into the combustion chambers of the engine. A fuel injection valve essentially comprises a pistonlike valve member, which is disposed longitudinally displaceably in a bore counter to a closing force and which has a pressure face that is located in a pressure chamber, where it is acted upon by the fuel pressure. Given a suitably high fuel pressure on the pressure face of the valve member, the valve member moves as a result of the hydraulic force against the pressure face in the longitudinal direction counter to the closing force, and thus opens at least one injection opening through which fuel is injected into the appropriate combustion chamber of the engine.

In the known fuel injection valve, a control valve is provided, which opens or interrupts the communication between the pressure chamber and the common rail. The closing force on the valve member is brought to bear by a closing spring embodied as a helical compression spring. If the control valve opens, fuel flows out of the common rail into the pressure chamber, so that the valve member uncovers the injection openings as soon as the hydraulic force on the pressure force suffices for the purpose. The end of injection occurs correspondingly, when the control valve interrupts the communication from the common rail to the pressure chamber. By the control valve, which is embodied as a 3/2-way valve, the pressure chamber is made to communicate with a leak fuel chamber acting as a relief chamber, which is constantly pressure relieved via a leak fuel line. As a result, the fuel pressure in the pressure chamber is reduced very quickly, and the valve member closes the injection openings again. The known fuel injection valve has the disadvantage that the closure of the needle can be controlled only indirectly via the decreasing fuel pressure in the pressure chamber. In modern fuel injection systems, which must be controlled quite precisely if optimal courses of combustion are to be achieved, this closing event may under some circumstances not be determined exactly enough. Furthermore, the known fuel injection valve has the disadvantage that the fuel pressure in the pressure chamber, when the valve member closing motion begins, has already dropped so much that the valve member, driven by the force of the closing spring, moves with its valve sealing face onto the valve seat virtually without being braked. Over long-term operation, excessive wear in the region of the valve seat can therefore occur, causing the injection characteristics of the fuel injection valve to vary disadvantageously over time.

From German Published, Nonexamined Patent Application DE 196 09 799 A1, a fuel injection system is also known in which the control of the valve member is effected by a suitable change in the closing force, while the hydraulic force on the pressure face of the valve member remains constant because of a constant communication with the common rail. To that end, a control valve is provided in the fuel injection system that can connect the high-pressure line, arriving from the common rail, with a control chamber. This control chamber is defined on one side by a piston, which is guided longitudinally displaceably and sealingly in a bore and is disposed coaxially with the valve member, with which it is connected via a pressure rod. If the valve member opens the communication of the high-pressure line with the control chamber, the result is a hydraulic closing force on the piston, which via the pressure rod presses the valve member into the closing position, so that it sits on the valve seat. Because of a suitable ratio of the pressure-impinged faces of the piston and the valve member, this hydraulic closing force is greater than the hydraulic opening force on the valve member, and the valve member remains in the closed position. If an injection is to take place, then the communication between the high-pressure line and the control chamber is interrupted, and the control chamber is made to communicate with a relief chamber. As a result, the hydraulic force on the piston drops, so that the hydraulic force on the pressure face of the valve member predominates, and the valve member executes an opening stroke motion that uncovers the injection openings. The injection is terminated again by the opening of the communication between the relief chamber and the control chamber by the control valve. The pressure in the control chamber accordingly rises to the pressure of the common rail, and the piston and thus the valve member move to the closing position. However, this fuel injection system has the disadvantage that the closure of the valve member, by means of the pressure in the common rail, accelerates the valve member toward the closing position sharply, so that it strikes the valve seat at a high speed. The result is a severe mechanical load there, which can cause excessive wear in this region.

### ADVANTAGES OF THE INVENTION

The fuel injection system of the invention having the definitive characteristics of claim 1 has the advantage over the prior art that the valve member is acted upon at least indirectly by the pressure in the control chamber, and the control chamber can be made to communicate with a relief chamber. The communication of the control chamber with the relief chamber is controlled by the valve member, so that because of the pressure in the control chamber, the additional closing force does not act constantly on the valve member. The control valve is embodied as a 3/2-way valve, which in the first position connects the high-pressure fuel source with the pressure chamber of the valve member and interrupts the communication between the pressure chamber and the control chamber. In the second position of the control valve, the communication with the high-pressure fuel source is closed, and the pressure chamber communicates with the control chamber. The pressure wave that occurs upon switching of the control valve is conducted into the control chamber, where it acts upon a control element that moves synchronously with the valve member. The control valve is switched via an electromagnet, for instance, so that the instant of switching can be set precisely.

Via a receiving bore, the control chamber communicates with a relief chamber, which communicates with a leak fuel system and in which a low fuel pressure prevails. A thrust bolt, which acts as a control element, is guided in the receiving bore and is connected to the valve member, so that it moves longitudinally in the receiving bore synchronously with the valve member in the opening stroke motion of the valve member. If fuel is to be injected into the combustion chamber of the engine, the control valve moves into the first position, and as a result of the fuel pressure in the pressure chamber, the valve member moves axially away from the valve seat and thus uncovers the injection openings. The termination of the injection is effected by switching the control valve to the second position, so that the high-pressure fuel line is closed and the pressure wave, which results from the closure of the control valve, is conducted into the control chamber. There, the thrust bolt is moved in the axial direction and thus the valve member is moved likewise via the pressure pin. Since at this instant a still relatively high fuel pressure prevails in the pressure chamber, the closing motion proceeds in damped fashion, which reduces the wear to the valve seat.

Furthermore, the present fuel injection system has the advantage that via the control chamber which is hydraulically closed off in the opening stroke motion of the valve member, a damping of the opening stroke motion of the valve member is also effected. As a result, the contact of the valve member with the stop face is damped, resulting in quieter operation and less wear in the region of the stop face.

In an advantageous feature of the subject of the invention, a control edge is disposed on the thrust bolt and cooperates with a sealing edge embodied on the end remote from the control chamber of the receiving bore. In the open position of the fuel injection valve, the control edge plunges into the receiving bore, so that the control chamber is sealed off from the relief chamber. In the course of the closing motion of the valve member, the thrust bolt also moves accordingly in the receiving bore, and after a portion of the total stroke, the control edge emerges from the receiving bore. As soon as the control edge passes the sealing edge, the relief chamber is made to communicate with the control chamber via recesses that are formed laterally on the thrust bolt, and thus the pressure in the control chamber is relieved. The thrust bolt and thus the valve member is accordingly moved in accelerated fashion by the fuel pressure in the control chamber only at the beginning of the closing motion, and thus the valve member takes its seat on the valve seat with a damped speed. This minimizes wear in the region of the valve seat and simultaneously enables exact, fast closure of the valve member.

Further advantages and advantageous features of the subject of the invention can be learned from the description, drawing and claims.

### DRAWING

In the drawing, one exemplary embodiment of a fuel injection system of the invention is shown.

FIG. 1 is a longitudinal section through a fuel injection valve and schematically shows the layout of the high-pressure fuel supply and the leak fuel system;

FIG. 2 shows an enlargement of FIG. 1 in the region of the shim;

FIG. 3 and

FIG. 4 are enlarged views of FIG. 1 in the region of the thrust bolt, where FIG. 3 shows the position of the thrust bolt in the closed position of the valve member and FIG. 4 shows the position of the thrust bolt in the open position of the valve member;

FIG. 5 shows a cross section through the fuel injection valve taken along the line V-V of FIG. 4;

FIG. 6 shows an enlarged view of the control valve in longitudinal section.

### DESCRIPTION OF THE EXEMPLARY EMBODIMENT

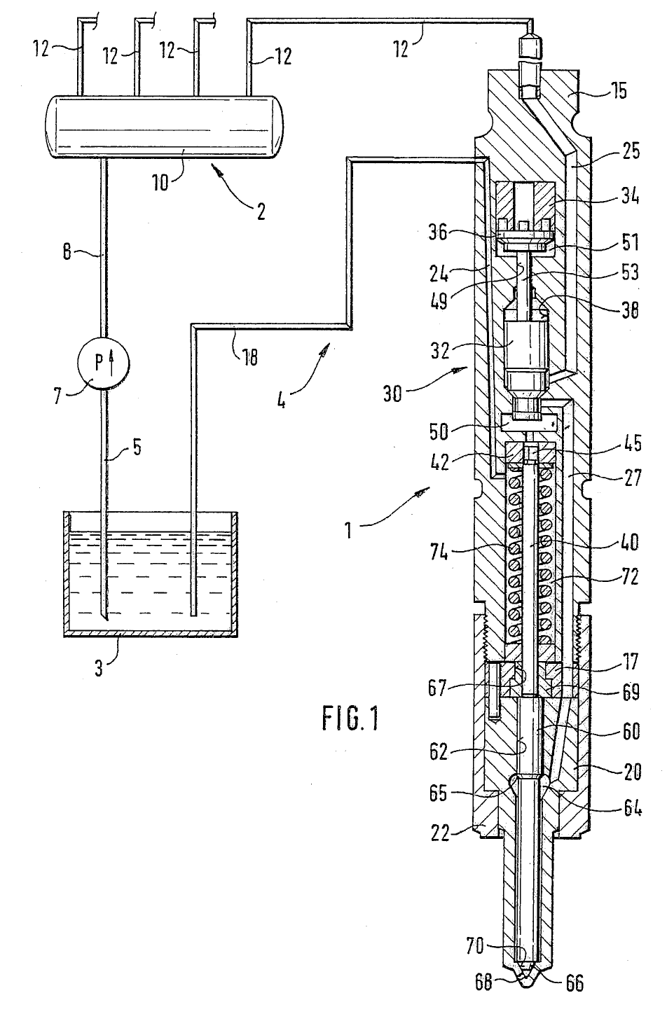

In FIG. 1, a fuel injection system is shown, which comprises a high-pressure fuel supply 2, a leak fuel system 4, and a fuel injection valve 1. The fuel injection valve 1 is shown in longitudinal section, while the high-pressure fuel supply 2 and the leak fuel system 4 are shown only schematically.

From a fuel tank 3, via a fuel line 5, fuel is delivered to a high-pressure pump 7, which pumps the fuel at high pressure via a high-pressure line 8 into a common rail 10 acting as a high-pressure fuel source. In the common rail 10, a specified high fuel pressure is maintained by a pressure regulating device, not shown in the drawing. From the common rail 10, many high-pressure lines 12 lead away, each communicating with one fuel injection valve 1, of which only one is shown in FIG. 1. The fuel injection valve 1 has a valve holding body 15, which with the interposition of a shim 17 is braced axially by a lock nut 22 against a valve body 20. In the valve holding body 15, an inlet conduit 25 is formed, which communicates with the high-pressure line 12 and by way of which fuel is introduced into the fuel injection valve 1. The inlet conduit 25 can be made to communicate, via a control valve 30, with an inlet bore 27, which extends through the valve holding body 15 and the shim 17 to the inside of the valve body 20. Embodied in the valve body 20 is a bore 62, in which a pistonlike valve member 60 is disposed longitudinally displaceably. The valve member 60 is guided sealingly in the bore 62 in a portion remote from the combustion chamber, then toward the combustion chamber it tapers, forming a pressure shoulder 65, and at its end it changes over into an essentially conical valve sealing face 66, which cooperates with a valve seat 70 embodied on the end toward the combustion chamber of the bore 62. In the valve seat 70, at least one injection opening 68, which connects the bore 62 to the combustion chamber of the engine, is formed. By means of a radial widening of the bore 62, a pressure chamber 64 is formed in the region of the pressure shoulder 65; this pressure chamber continues, in the form of an annular conduit surrounding the valve member 60, as far as the valve seat 70. The inlet bore 27 discharges into the pressure chamber 64, so that the pressure chamber 64 can be filled with fuel at high pressure via the inlet bore 27.

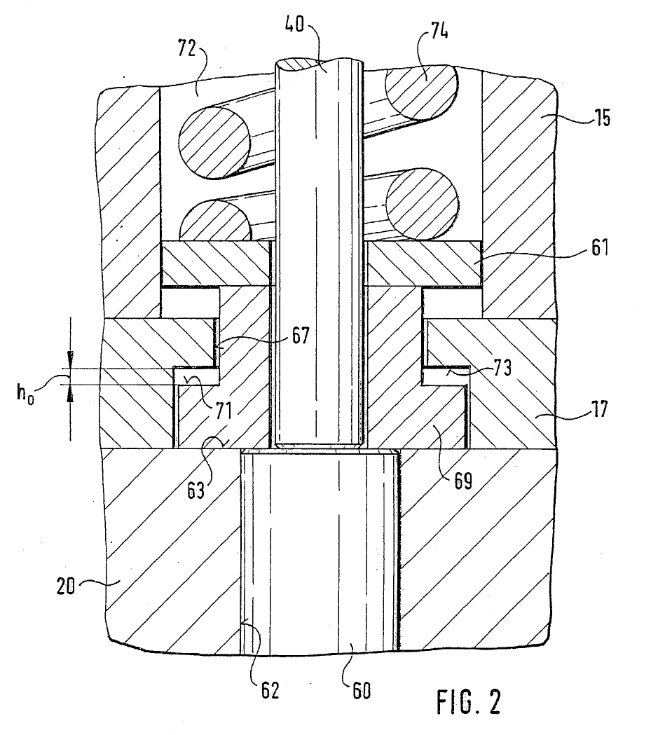

In the valve holding body 15, a spring chamber 72 is embodied, which acts as a relief chamber and is embodied as a bore that is disposed coaxially to the bore 62 and communicates with the bore 26 via a central opening 67 made in the shim 17. The spring chamber 72 communicates with an outlet conduit 24 embodied in the valve holding body 15, and this outlet conduit 24 communicates with the fuel tank 3 via a leak fuel line 18, so that a low fuel pressure always prevails in the spring chamber 72. In FIG. 2, an enlargement of FIG. 1 in the region of the shim 17 is shown. Disposed in the central opening 67 in the shim 17 is a sleeve 69 which is longitudinally displaceable in the central opening 67 and which, with its face end toward the valve member 60, rests on the face end of the valve member 60 remote from the combustion chamber. With the interposition of an annular-disklike spring plate 61, a helical compression spring 74 is disposed with prestressing between the sleeve 69 and the end, remote from the combustion chamber, of the spring chamber 72; as a result, the prestressing of the helical compression spring 74 exerts a force that acts in the axial direction on the valve seat 70 via the sleeve 69 and thus acts on the valve member 60 in the closing direction. The valve member 60 is thus pressed with its valve sealing face 66 against the valve seat 70, so that the injection openings 68 are closed, if no force oriented counter to the spring force is acting on the valve member 60.

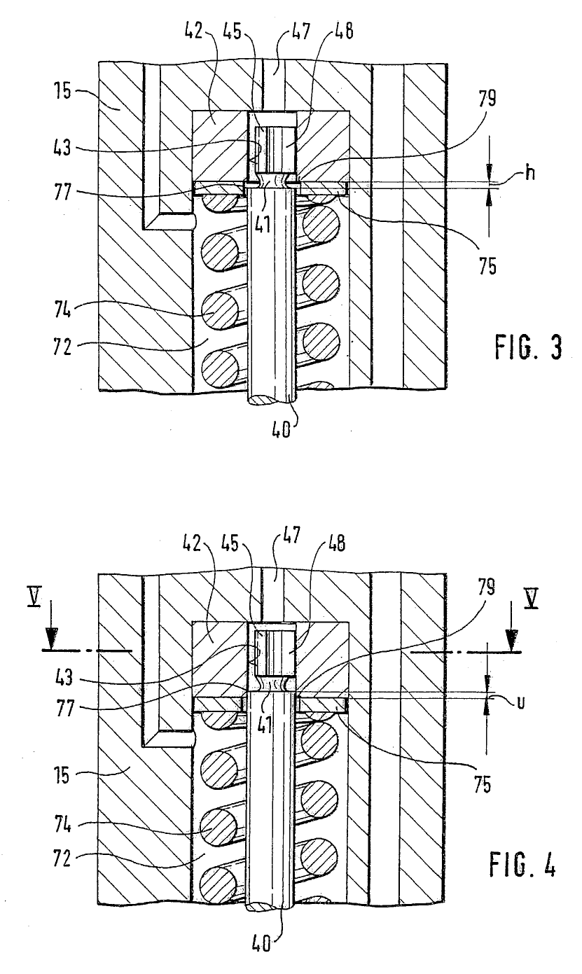

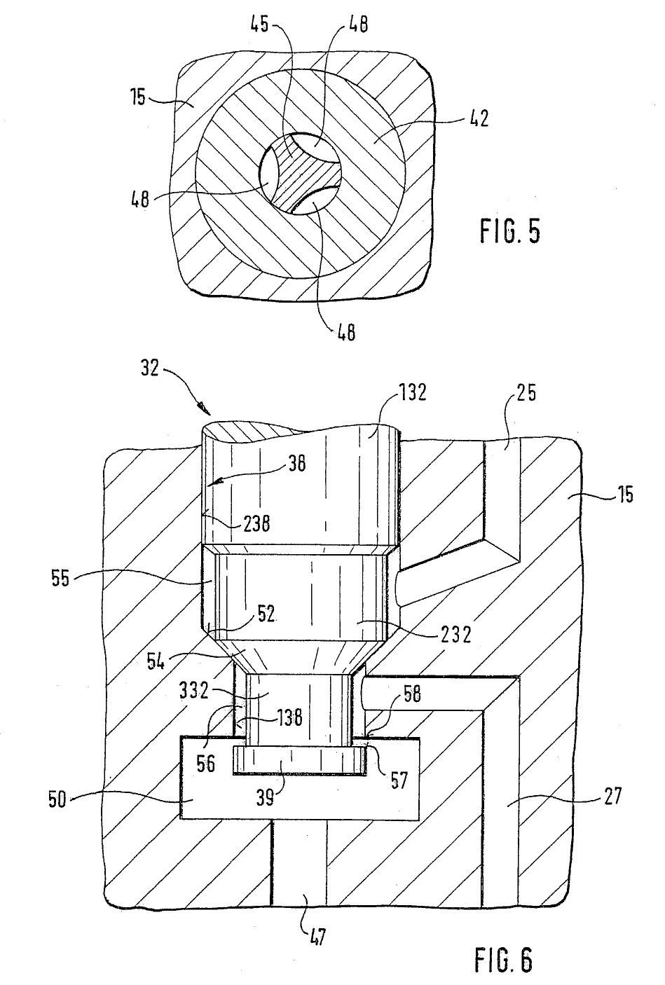

The central opening 67 is embodied with a stepped diameter, so that an annular stop face 73 oriented toward the valve member 60 is formed in the shim 17. The sleeve 69 is likewise stepped in its outside diameter and tapers, forming an annular stop shoulder 71, toward the spring chamber 72. In the closing position of the valve member 60, or in other words when the valve member 60 rests with its valve sealing face 66 on the valve seat 70, the sleeve 69 comes to rest on the face end 63, remote from the combustion chamber, of the valve body 20. In this position, the stop shoulder 71 has an axial spacing from the stop shoulder 73, and this spacing defines the total stroke h₀ of the valve member 60. A pressure pin 40 rests on the face end, remote from the combustion chamber, of the valve member 60; it is disposed coaxially to the valve member 60 and protrudes as far as the inside of the spring chamber 72, where it is surrounded by the helical compression spring 74. The end piece, remote from the combustion chamber, of the pressure pin 40 is embodied as a thrust bolt 45, which acts as a control element and is disposed in a receiving bore 43 of a guide sleeve 42 that is disposed between the end, remote from the combustion chamber, of the helical compression spring 74 and the end, remote from the combustion chamber, of the spring chamber 72. In FIGS. 3 and 4, enlarged views of this region of the fuel injection valve are shown. Between the helical compression spring 74 and the guide sleeve 42, a compensation disk 75 may be provided, by way of whose axial expansion the prestressing of the helical compression spring 74 can be adjusted. The thrust bolt 45 is guided in the receiving bore 43 and is separated from the pressure pin 40 by an annular groove 41. The thrust bolt 45 has lateral recesses 48, by which the annular groove 41 communicates with the face end, remote from the combustion chamber, of the thrust bolt 45. In FIG. 5, the shape of the recesses 48 is shown, in a cross section of the fuel injection valve taken along the line V-V of FIG. 4 in the region of the thrust bolt 45. The pressure pin 40 has a diameter that is only slightly less than the diameter of the receiving bore 43, so that upon plunging into the receiving bore 43 the pressure pin 40 is guided sealingly there. The edge of the annular groove 41 oriented toward the pressure pin 40 forms a control edge 77, which cooperates with the sealing edge 79 formed on the end, toward the combustion chamber, of the receiving bore 43. By the longitudinal motion of the valve member 60, the thrust bolt 45 is also moved longitudinally via the pressure pin 40. When the fuel injection valve is closed, that is, when the valve member 60 rests with its valve sealing face 66 on the valve seat 70 and closes the injection openings 68, the sealing edge 79 is located outside the receiving bore 43, and the spring chamber 72 communicates with the receiving bore 43 via the recesses 48. This situation is shown in FIG. 3. The axial spacing of the sealing edge 79 from the control edge 77 results in the free stroke h. In the open state of the fuel injection valve, the control edge 77 plunges into the receiving bore 43. As soon as the control edge 77 moves past the sealing edge 79, the receiving bore 43 is closed by the pressure pin 40, which has only a very slight play in the receiving bore 43. This position of the thrust bolt 43 is shown in FIG. 4; the axial spacing of the control edge 77 from the sealing edge 79 in this state of the fuel injection valve is marked as an overlap u. The total stroke h₀ is equivalent to the sum (h₀=h+u) of the free stroke h and the overlap u.

The precise structure of the control valve 30 is shown in longitudinal section in FIG. 6. The receiving bore 43 communicates, via a connecting bore 47 in the valve holding body 15, with a control chamber 50 disposed in the valve holding body 15; the control chamber is embodied cylindrically and merges, remote from the valve member 60, with a control bore 38. The control bore 38 is embodied parallel to the bore 60, but provision can also be made for the two bores to form an angle with one another or be perpendicular to one another. The control bore 38 is embodied with a stepped diameter: The control chamber 50 is adjoined by a slide portion 138, which over the further course is widened radially, forming a conical control valve seat 52 and changes into a guide portion 238. On its end remote from the control chamber 50, the control bore 38 communicates via an intermediate bore 49 with a leak fuel chamber 51, which communicates with the outlet conduit 24 and in which there is an electromagnet 34 that is operatively connected to a magnet armature 36 likewise disposed in the leak fuel chamber 51. A pistonlike control valve member 32 is disposed in the control bore 38 and is guided sealingly by a first portion 132 in the guide portion 238. Toward the control chamber 50, the control valve member 32 tapers and changes into a smaller-diameter second portion 232, so that an annular first high-pressure chamber 55, into which the inlet conduit 25 discharges, is formed between the second portion 232 of the control valve member 32 and the wall of the guide portion 238 of the control valve bore 38. In its further course toward the control chamber 50, the control valve member 32 changes over, forming a conical control valve sealing face 54, into a third portion 332 of the control valve member 32 of reduced diameter compared to the second portion 232. This third portion 332 is disposed inside the slide portion 138, so that a second high-pressure chamber 58, which is likewise annular, is formed between the third portion 332 of the control valve member 32 and the wall of the control valve bore 38. The control valve sealing face 54 together with the control valve seat 52 forms a first valve, by which the inlet conduit 25 can be made to communicate with the inlet bore 27. The end of the control valve member 32 oriented toward the control chamber 50 is formed by a slide head 39 of increased diameter compared with the third portion 332 of the control valve member 32; this slide head protrudes into the control chamber 50 when the control valve sealing face 54 is in contact with the control valve seat 52. On the end of the slide head 39 remote from the control chamber 50, a slide edge 57 is formed on the head; this slide edge cooperates with a sealing edge 58 formed at the transition from the control valve bore 38 to the control chamber 50. The diameter of the slide head 39 is only slightly less than the diameter of the slide bore 138 of the control valve bore 38, so that the slide head 39 can plunge sealingly into the slide bore 138. As soon as the slide edge 57 reaches the sealing edge 58 in the longitudinal motion of the control valve member 32, the communication between the second high-pressure chamber 56 and the control chamber 50 is interrupted, thereby forming a second valve embodied as a slide valve.

On the end remote from the control chamber 50, the control valve member 32 is connected to the magnet armature 36 via a pin 53. If suitable current is supplied to the electromagnet 34, the magnet armature 36 and, via the pin 51, the control valve member 32 as well are moved axially away from the combustion chamber, so that the control valve sealing face 54 lifts from the control valve seat 52 and connects the first high-pressure chamber 55 to the second high-pressure chamber 56. As soon as the slide edge 57 of the slide head 39 and the sealing edge 58, which is formed on the end of the slide bore 138 toward the combustion chamber, are opposite one another, the slide head 39 closes off the control chamber 50 from the second high-pressure chamber 56. As a result, the inlet conduit 25 and the inlet bore 27 now communicate with one another via the first high-pressure chamber 55 and the second high-pressure chamber 56, so that fuel can flow at high pressure into the pressure chamber 64. By supplying a different to the electromagnet 34, the magnet armature 36 is moved back in the opposite direction again, so that the control valve member 32 comes to rest with its control valve sealing face 54 on the control valve seat 52 again and thus closes off the first high-pressure chamber 55 from the second high-pressure chamber 56. The slide head 39 thus emerges from the guide portion 138 again, so that now via the second high-pressure chamber 56, the inlet bore 27 communicates with the control chamber 50. The two valves formed by the control valve member 32 together form a 3/2-way valve, which connects the control chamber 50, inlet bore 27 and inlet conduit 25 with one another in alternation.

The mode of operation of the fuel injection valve is as follows:

The common rail 10 communicates with the first high-pressure chamber 55 via the high-pressure line 12 and the inlet conduit 25, so that a high fuel pressure prevails in the first high-pressure chamber 55. If the injection is to occur, then by suitably supplying current to the electromagnet 34 the magnet armature 36 is moved in the axial direction, causing the control valve member 32 to execute an axial motion and to lift with its control valve sealing face 54 from the control valve seat 52. At the same time, the slide head 39 plunges into the slide portion 138 of the control valve bore 38 and closes the second high-pressure chamber 56 off from the control chamber 50. Since the inlet conduit 25 and the inlet bore 27 now communicate with one another, fuel flows at high pressure into the pressure chamber 64, where it increases the hydraulic force on the pressure shoulder 65 of the valve member 60. If this hydraulic force exceeds the force of the helical compression spring 74, then the valve member 60 moves axially away from the combustion chamber and lifts with its valve sealing face 66 from the valve seat 70, thus connecting the pressure chamber 64 to the injection openings 68, so that fuel is injected into the combustion chamber of the engine. By means of the opening stroke motion of the valve member 60, the pressure pin 40 is also moved in the axial direction. As soon as the valve member 60 has traversed the free stroke h, the control edge 77, embodied at the transition of the pressure pin 40 to the thrust bolt 45, plunges into the receiving bore 43 of the guide sleeve 42, so that the control chamber 50 is hydraulically closed and thus serves as a hydraulic buffer for the opening stroke motion of the valve member 60. Once the free stroke h has been traversed, the opening stroke motion of the valve member 60 thus slows down, and the valve member thus seats itself with damped speed indirectly by means of the sleeve 69 on the stop face 73 of the shim 17. The end of the injection is tripped by a suitable supply of current to the electromagnet 34, which displaces the magnet armature 36 axially toward the combustion chamber, as a result of which the control valve member 32 is also moved in the axial direction. As soon as the slide edge 57 of the slide head 39 emerges from the slide bore 138, the first high-pressure chamber 55 communicates with the control chamber 50 for a brief period of time, specifically until such time as the control valve sealing face 54 again comes into contact with the control valve seat 52 and closes the inlet conduit 25. As a result of this brief communication of the control chamber 50 with the first high-pressure chamber 55 via the second high-pressure chamber 56, and as a result of the expanding fuel in the pressure chamber 64, a pressure wave is created, which spreads into the control chamber 50. As a result of this pressure wave, a force is exerted on the face end, remote from the combustion chamber, of the thrust bolt 45, so that via the pressure pin 40 the valve member 60 is also moved in accelerated fashion toward the combustion chamber, with greater force and hence faster than would be possible by means of the helical compression spring 74 alone. However, the force on the thrust bolt 45 continues only until the control edge 77 is inside the receiving bore 43. As soon as the control edge 77 emerges from the receiving bore 43, after passing through the overlap u, the control chamber 50 is made to communicate with the spring chamber 72 via the recesses 48 and the annular groove 41. The fuel pressure in the control chamber 50 quickly drops as a result to the value of the pressure prevailing in the spring chamber 72, so that the hydraulic force on the thrust bolt 45 decreases. Since at this instant a relatively high fuel pressure still prevails in the pressure chamber 64, the further closing motion of the valve member 60 toward the valve seat 66 is hydraulically damped by the fuel pressure in the pressure chamber 64, so that after an initially fast axial closing motion, the valve member 60 comes to rest relatively gently with its valve sealing face 66 on the valve seat 70.

Besides the thrust bolt 45, it is also possible to embody the fuel injection valve in some other form. For instance, the thrust bolt can be embodied with a rectangular cross section, which is guided in an equally rectangular connecting opening. It is also possible to embody the connection of the thrust bolt to the valve member not by means of a rigid mechanical connection but by means of a hydraulic coupling of the two elements. It is furthermore possible to embody the communication of the control chamber with the relief chamber through an additional connecting conduit, which is opened or closed as a function of the stroke of the valve member.

1. A fuel injection system for internal combustion engines, having a fuel injection valve (1) that has a valve body (20), in which a valve member (60) is disposed axially movably in a bore (62), which valve member (60), hydraulically controlled by the fuel pressure in a pressure chamber (64), is longitudinally displaceable counter to a closing force and thereby controls at least one injection opening (68), and having a control valve (30) by which the communication of the pressure chamber (64) with a high-pressure fuel source (10) and with a relief chamber (72) is controlled (3/2-way valve), wherein the control valve (30) includes a control valve member (32) which is longitudinally displaceable in a control valve bore (38), which control valve member (32), in a first position for opening the fuel injection valve (1), opens the communication of the high-pressure fuel source (10) with the pressure chamber (64) and interrupts the communication of the relief chamber (72) with the pressure chamber (64), and in a second position for closing the fuel injection valve (1) connects the pressure chamber (64) to the relief chamber (72) and in the process interrupts the communication of the pressure chamber (64) with the high-pressure fuel source (10), the valve member (60) being acted upon in the closing direction at least indirectly by the pressure prevailing in the relief chamber (72), characterized in that a control chamber (50), which has a communication with the relief chamber (72) that is controlled at least indirectly by the valve member (60), is disposed in the communication of the control valve (30) with the relief chamber (72).

2. The fuel injection system of claim 1, characterized in that the control chamber (50) is defined by a movable control element, which moves synchronously with the valve member (60) and is acted upon by the pressure in the control chamber (50) and as a result presses the valve member (60) in the closing direction.

3. The fuel injection system of claim 2, characterized in that the control element opens the communication of the control chamber (50) with the relief chamber (72) in the closing position of the valve member (60) and closes it in the open position of the valve member (60).

4. The fuel injection system of claim 2 or 3, characterized in that the control element is embodied as a thrust bolt (45) which is connected to the valve member (60) and is guided in a receiving bore (43) and acted upon by the pressure in the control chamber (50), and the receiving bore (43) forms the communication of the control chamber (50) with the relief chamber (72).

5. The fuel injection system of claim 4, characterized in that a control edge (77) is disposed on the thrust bolt (45) and cooperates with a sealing edge (79) embodied on the end remote from the control chamber of the receiving bore (43).

6. The fuel injection system of claim 5, characterized in that the control edge (77) of the thrust bolt (45) is connected to the face end toward the control chamber of the thrust bolt (45) via at least one recess (48) embodied on the thrust bolt (45).

7. The fuel injection system of claim 6, characterized in that the control edge (77) of the thrust bolt (45) emerges from the receiving bore (47) after a portion of the total stroke of the thrust bolt (45), as a result of which the control chamber (50) communicates with the relief chamber (72).

8. The fuel injection system of claim 4, characterized in that the thrust bolt (45) is disposed coaxially to the valve member (60).

9. The fuel injection system of claim 8, characterized in that the thrust bolt (45) is connected to the valve member (60) via a pressure pin (40) disposed coaxially to the valve member (60).

10. The fuel injection system of claim 1, characterized in that upon the motion of the control valve member (32) between its first and second position, the control chamber (50) communicates in an intermediate position of the control valve member (32) with the high-pressure fuel source (10).

11. The fuel injection system of one of the foregoing claims, characterized in that the high-pressure fuel source (10) is a high-pressure collection chamber (common rail).
